(19) United States
(12) Patent Application Publication
(10) Pub. No.: US 2021/0240410 A1
(43) Pub. Date: Aug. 5, 2021

(54) PRINTER AND METHOD

(71) Applicant: TOSHIBA TEC KABUSHIKI KAISHA, Tokyo (JP)

(72) Inventor: Chikahiro Saegusa, Sunto Shizuoka (JP)

(21) Appl. No.: 17/106,424

(22) Filed: Nov. 30, 2020

(30) Foreign Application Priority Data
Feb. 3, 2020 (JP) 2020-016159

(51) Int. Cl. G06F 3/12

(52) U.S. Cl. CPC G06F 3/1221; G06F 3/1273; G06F 3/122; G06F 3/1229

(57) ABSTRACT

According to one embodiment, a printer includes a printing unit, a communication unit, an operation unit, a time tracking unit, a first setting unit, and a power control unit. The printing unit is configured to execute printing. The communication unit is configured to execute communication. The operation unit is configured to receive an operation. The time tracking unit is configured to acquire current time. The first setting unit configured to set a time zone in which power supply of a battery is stopped to first setting information based on a usage history of the own apparatus. The power control unit configured to stop power supply of the battery to the printing unit, the communication unit, and the operation unit based on the current time acquired by the time tracking unit and the first setting information.

### CROSS-REFERENCE TO RELATED APPLICATION

This application is based upon and claims the benefit of priority from Japanese Patent Application No. P2020-016159, filed on Feb. 3, 2020 the entire contents of which are incorporated herein by reference.

### FIELD

Embodiments described herein relate generally to a printer and a method.

### BACKGROUND

In the related art, in a case where a printer is not used, power supply to a component used for printing, for example, a print head is stopped. As a result, power consumption in a printer can be reduced.

However, in the printer, power is supplied to an operation unit, a communication unit, or the like. Therefore, for the printer, there is room for further reduction in power consumption.

### DESCRIPTION OF THE DRAWINGS

FIG. 1 is a diagram illustrating an example of a print system according to an embodiment;

FIG. 2 is a block diagram illustrating an example of a hardware configuration of a printer;

FIG. 3 is a diagram illustrating an example of a data configuration of mode shift setting information;

FIG. 4 is a block diagram illustrating a configuration of characteristic functions in the printer; and

FIG. 5 is a flowchart illustrating an example of a mode shift process that is executed by the printer.

### DETAILED DESCRIPTION

Embodiments provide a printer and a method capable of reducing power consumption.

In general, according to one embodiment, a printer includes a printing unit, a communication unit, an operation unit, a time tracking unit, a first setting unit, and a power control unit. The printing unit is configured to execute printing. The communication unit is configured to execute communication. The operation unit is configured to receive an operation. The time tracking unit is configured to acquire current time. The first setting unit is configured to set a time zone in which power supply of a battery is stopped to first setting information based on a usage history of the own apparatus. The power control unit is configured to stop power supply of the battery to the printing unit, the communication unit, and the operation unit based on the current time acquired by the time tracking unit and the first setting information.

Hereinafter, an embodiment of a printer and a method will be described in detail with reference to the accompanying drawings. An embodiment described below is an embodiment of the printer and the method, and a configuration, a specification, or the like is not limited.

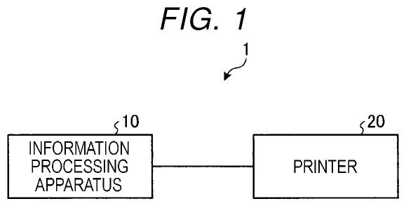

FIG. 1 is a diagram illustrating an example of a print system 1 according to the embodiment. The print system 1 includes an information processing apparatus 10 and a printer 20. The information processing apparatus 10 and the printer 20 are communicatively connected to each other through a network. The print system 1 illustrated in FIG. 1 includes one information processing apparatus 10 and one printer 20. However, the print system 1 may include a plurality of information processing apparatuses 10 or a plurality of printers 20.

The information processing apparatus 10 is an apparatus such as a personal computer or a point of sales (POS) terminal. The information processing apparatus 10 transmits a print request including print data to be printed to the printer 20. As a result, the information processing apparatus 10 causes the printer 20 to print the print data.

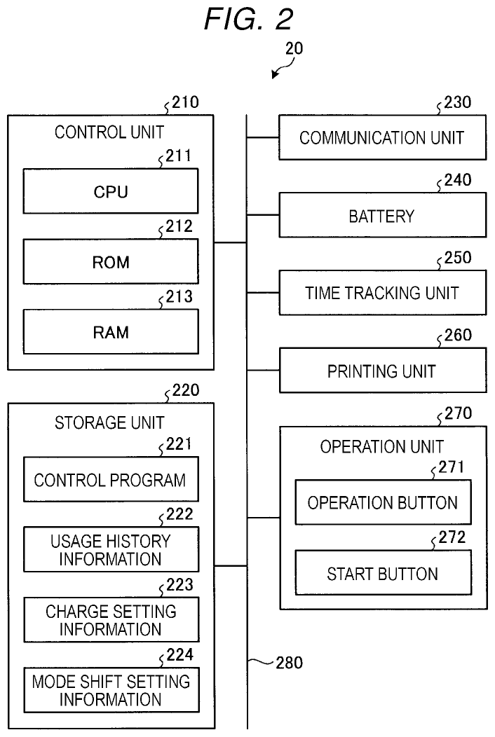

The printer 20 is a printing apparatus that is driven by power charged in a battery 240 (refer to FIG. 2). The printer 20 prints the print data transmitted from the information processing apparatus 10. Alternatively, when the printer 20 receives an operation to print, the printer 20 prints the instructed print data.

Here, the printer 20 includes four modes relating to power consumption. The modes include an operation mode, a standby mode, a first sleep mode, and a second sleep mode. In the operation mode, the print 20 is in a printable state, and power is supplied to the respective units. In the standby mode, the printer 20 is in a standby state, and a power request for a printing unit 260 (refer to FIG. 2) is stopped. In the first sleep mode, power supply to the printing unit 260 (refer to FIG. 2), a communication unit 230 (refer to FIG. 2), and an operation button 271 (refer to FIG. 2) is stopped. In the second sleep mode, power supply to the printing unit 260 (refer to FIG. 2), the communication unit 230 (refer to FIG. 2), and an operation unit 270 (refer to FIG. 2) is stopped. The power consumption decreases in order of the operation mode, the standby mode, the first sleep mode, and the second sleep mode.

By appropriately shifting the printer 20 to the four modes relating to power consumption, power consumption is reduced.

Next, a hardware configuration of the printer 20 will be described.

FIG. 2 is a block diagram illustrating an example of the hardware configuration of the printer 20. The printer 20 includes a control unit 210, a storage unit 220, the communication unit 230, the battery 240, a time tracking unit 250, the printing unit 260, and the operation unit 270. The respective units are connected to each other through a system bus 280 such as a data bus or an address bus.

The control unit 210 is a computer that controls an overall operation of the printer 20 and implements various functions in the printer 20. The control unit 210 includes a central processing unit (CPU) 211, a read only memory (ROM) 212, and a random access memory (RAM) 213. The CPU 211 integrally controls the operation of the printer 20. The ROM 212 is a storage medium that stores various programs or data. The RAM 213 is a storage medium that temporarily stores various programs or various data. The CPU 211 executes a program stored in the ROM 212, the storage unit 220, or the like by using the RAM 213 as a work area.

The storage unit 220 is a non-volatile storage device such as a flash memory. The storage unit 220 stores a control program 221, usage history information 222, charge setting information 223, and mode shift setting information 224. The usage history information 222, the charge setting information 223, and the mode shift setting information 224 are not limited to being stored in the storage unit 220 and may be stored in another apparatus connected to the printer 20 through a network. If the usage history information 222, the charge setting information 223, and the mode shift setting information 224 are stored in another apparatus, the printer 20 may acquire or update information through communication.

The control program 221 causes an operating system or a function in the printer 20 to be exhibited. The control program 221 includes a program that causes characteristic functions according to the embodiment to be exhibited.

In the usage history information 222, a usage history of the own apparatus is recorded. Specifically, the usage history information 222 includes date and time information, use content information, and used power amount information. The date and time information, the use content information, and the used power amount information correlate to each other. The date and time information represents the date and time at which the own apparatus is used. The use content information represents a use content. For example, the use content information represents a use content such as printing of a receipt. The used power amount information represents the amount of power used to execute the use content represented by the use content information. In the usage history information 222, a usage history of one year, a usage history of one month, a usage history of one week, or a usage history of another period may be recorded.

The charge setting information 223 represents the charge amount in which the battery 240 is charged. Specifically, the charge setting information 223 represents the percentage that the charge capacity reaches when the battery 240 is charged. Here, if the battery 240 is charged until the charge capacity reaches 100%, the battery 240 deteriorates at an early stage. Therefore, by restricting the charge amount, the time when the battery 240 deteriorates can be delayed. If the charge amount is measured based on a voltage, the charge setting information 223 may be a voltage value. The charge setting information 223 is not limited to a voltage value and may be information representing another numerical value.

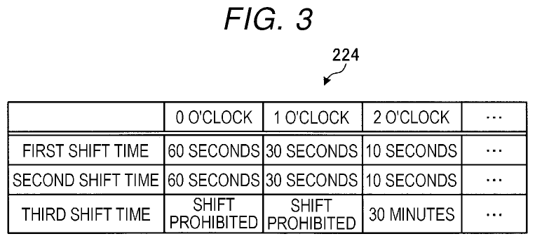

The mode shift setting information 224 represents a setting relating to a mode shift for reducing power consumption of the printer 20. Here, FIG. 3 is a diagram illustrating an example of a data configuration of the mode shift setting information 224. In the mode shift setting information 224, a time at which the printer 20 is shifted to each of the modes is set per time zone. Specifically, a first shift time, a second shift time, and a third shift time are set per time zone.

At the first shift time, the printer 20 is shifted from the operation mode to the standby mode. When the first shift time is elapsed in the operation mode without using the printer 20, the printer 20 is shifted to the standby mode. At the second shift time, the printer 20 is shifted from the standby mode to the first sleep mode. When the second shift time is elapsed in the standby mode, the printer 20 is shifted to the first sleep mode. At the third shift time, the printer 20 is shifted from the first sleep mode to the second sleep mode. When the third shift time is elapsed in the first sleep mode, the printer 20 is shifted to the second sleep mode. In a time zone in which the shift to the second sleep mode is prohibited, shift prohibition to the third shift time is set in the mode shift setting information 224. The shift prohibition is not limited to being set to the second sleep mode and may be set to the standby mode or the first sleep mode.

In the mode shift setting information 224 illustrated in FIG. 3, the time at which the printer 20 is shifted to each of the modes is set per hour, for example, 0:00 to 0:59, 1:00 to 1:59, and 2:00 to 2:59. However, in the mode shift setting information 224, the time at which the printer 20 is shifted to each of the modes may be set per 30 minutes, per 10 minutes, or per another time.

The communication unit 230 executes communication. For example, the communication unit 230 is an interface for executing communication with the information processing apparatus 10.

The battery 240 is a rechargeable secondary battery such as a lithium ion battery. The battery 240 is charged with power that is used for the respective units of the printer 20.

The time tracking unit 250 acquires the current date and time. For example, the time tracking unit 250 is a clock.

The printing unit 260 executes printing. The printing unit 260 includes a print head that executes printing a printing medium such as paper, a conveyance mechanism that conveys paper, and the like.

The operation unit 270 receives an operation. The operation unit 270 includes the operation button 271 and a start button 272. The operation button 271 is a button for receiving an operation regarding printing or an operation of changing various settings. The start button 272 is a button for shifting the printer 20 from the first sleep mode to the operation mode.

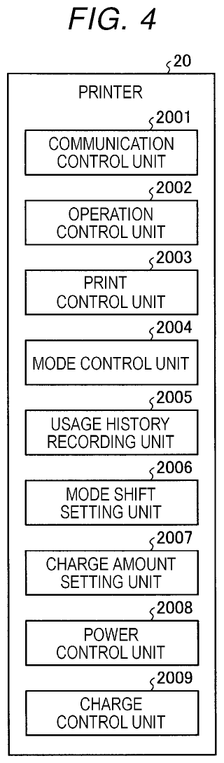

Next, the characteristic functions in the printer 20 will be described. Here, FIG. 4 is a block diagram illustrating a configuration of the characteristic functions in the printer 20.

The control unit 210 of the printer 20 loads the control program 221 stored in the storage unit 220 to the RAM 213, and operates according to the control program 221 to generate the respective functional units in the RAM 213. Specifically, the control unit 210 of the printer 20 includes, as the functional units, a communication control unit 2001, an operation control unit 2002, a print control unit 2003, a mode control unit 2004, a usage history recording unit 2005, a mode shift setting unit 2006, a charge amount setting unit 2007, a power control unit 2008, and a charge control unit 2009.

The communication control unit 2001 controls the communication unit 230 to execute communication with the information processing apparatus 10. For example, the communication control unit 2001 receives a print request including print data.

The operation control unit 2002 controls the operation unit 270 to receive various operations. For example, the operation control unit 2002 receives an operation regarding printing through the operation button 271. The operation control unit 2002 receives an operation of shifting the printer 20 from the first sleep mode to the operation mode through the start button 272.

The print control unit 2003 controls the printing unit 260 to print the print data on a printing medium. More specifically, the print control unit 2003 executes printing when the communication control unit 2001 receives a print request or when the operation control unit 2002 receives an operation regarding printing.

The mode control unit 2004 controls the shift between modes regarding the power consumption of the printer 20 based on the mode shift setting information 224 and the current time acquired by the time tracking unit 250. More specifically, when the first shift time set for the time zone belonging to the current time is elapsed in the operation mode after the operation control unit 2002 receives the operation, the mode control unit 2004 shifts the printer 20 to the standby mode. Alternatively, when the first shift time set for the time zone belonging to the current time is elapsed in the operation mode after the communication control unit 2001 receives the print request, the mode control unit 2004 shifts the printer 20 to the standby mode.

When the second shift time set for the time zone belonging to the current time is elapsed after the printer 20 is shifted to the standby mode, the mode control unit 2004 shifts the printer 20 to the first sleep mode. If an operation shift condition is satisfied in the standby mode, the mode control unit 2004 shifts the printer 20 to the operation mode. For example, the operation shift condition is the reception of the print request by the communication control unit 2001 or the reception of the operation by the operation control unit 2002. That is, if the print request is received or the operation is received in the standby mode, the mode control unit 2004 shifts the printer 20 to the operation mode.

If the third shift time set for the time zone belonging to the current time is elapsed after the printer 20 is shifted to the first sleep mode, the mode control unit 2004 shifts the printer 20 to the second sleep mode. If the start button 272 is pressed in the first sleep mode, the mode control unit 2004 shifts the printer 20 to the operation mode.

If an end time of the second sleep mode set in the mode shift setting information 224 is reached in the second sleep mode, the mode control unit 2004 shifts the printer 20 to the operation mode. Specifically, if a time zone for which shift prohibition is set to the third shift time in the mode shift setting information 224 is reached, the mode control unit 2004 shifts the printer 20 to the operation mode. The mode control unit 2004 is not limited to shifting the printer 20 to the operation mode and may shift the printer 20 to the first sleep mode or the standby mode.

Here, in the second sleep mode, the mode control unit 2004 may not shift the printer 20 to another mode through communication, when the operation button 271 is pressed, or when the start button 272 is pressed. Therefore, even if a user wants to use the printer 20 in the second sleep mode, the user cannot use the printer 20 until the time zone for which shift prohibition is set is reached. Therefore, the mode control unit 2004 may shift the printer 20 to the operation mode, the standby mode, or the first sleep mode whenever the time zone ends. For example, if the printer 20 is shifted to the second sleep mode at 1:30 and can be shifted to the second sleep mode in a time zone from 2:00 to 2:59, the mode control unit 2004 may shift the printer 20 to the operation mode, the standby mode, or the first sleep mode when the end time of 1:59 is reached as a condition. As a result, the user can obtain the opportunity to use the printer 20.

The usage history recording unit 2005 records a usage history of the own apparatus. More specifically, the usage history recording unit 2005 records the date and time information, the use content information, the used power amount information in the usage history information 222.

The mode shift setting unit 2006 sets the first shift time, the second shift time, and the third shift time to the mode shift setting information 224 per time zone based on the usage history information 222. That is, the mode shift setting unit 2006 sets a time zone in which power supply of the battery 240 is stopped to the mode shift setting information 224 based on the usage history of the own apparatus.

More specifically, the mode shift setting unit 2006 specifies the number of times the printer 20 is used per time zone of the mode shift setting information 224 based on the usage history information 222. Here, the number of times the printer 20 is used may be a total value of all the periods stored in the usage history information 222 or may be a total value of some periods. The number of times the printer 20 is used may be a statistical value such as an average value, a median value, or a mode value of all the periods or some periods stored in the usage history information 222. The number of times the printer 20 is used is counted based on the number of times the printer 20 is shifted to the operation mode, the number of times the printer 20 executes a printing process, or the like. In the usage history information 222, a usage time may be used instead of the number of times the printer 20 is used. As the usage time, for example, a total value of times at which the printer 20 is in the operation mode per time zone or a total value of times at which the printer 20 is in the operation mode and times at which the printer 20 is in the standby mode is appropriately set.

The mode shift setting unit 2006 sets the time corresponding to the specified number of times the printer 20 is used to the mode shift setting information 224 as the first shift time, the second shift time, or the third shift time based on a correspondence table in which the number of times the printer 20 is used and the time at which the printer 20 is shifted are associated with each other. The mode shift setting unit 2006 is not limited to acquiring the time based on the correspondence table, and may calculate the time from a calculation formula, may derive the time from an algorithm, or may acquire the time using another method.

If it is not desirable to shift the printer 20 to the second sleep mode, the mode shift setting unit 2006 sets shift prohibition to the third shift time. For example, if the number of times the printer 20 is used in the corresponding time zone is a threshold or higher, the mode shift setting unit 2006 sets shift prohibition.

The charge amount setting unit 2007 sets the charge amount in which the battery 240 is charged to the charge setting information 223 based on the usage history information 222. More specifically, the charge amount setting unit 2007 calculate the amount of power used for one day based on the usage history information 222. That is, the charge amount setting unit 2007 calculates a statistical value such as an average value of the amounts of power used for one day. The charge amount setting unit 2007 sets the calculated amount of power to the charge setting information 223 as the charge amount. The charge amount setting unit 2007 is not limited to calculating the average value of the amounts of power used for one day, and may calculate a median value, a mode value, or another value.

Here, the rechargeable charge capacity of the battery 240 decreases due to deterioration over time. That is, if the first charge amount and the second or subsequent charge amount are set to be the same, power supplied to the printer 20 may be insufficient. Therefore, the charge amount setting unit 2007 changes the charge amount depending on the number of times the battery 240 is charged.

The power control unit 2008 supplies power of the battery 240 to the printing unit 260, the communication unit 230, the operation unit 270, and the time tracking unit 250 according to the mode relating to power consumption. More specifically, in the operation mode, the power control unit 2008 supplies power of the battery 240 to the printing unit 260, the communication unit 230, the operation unit 270, and the time tracking unit 250.

In the standby mode, the power control unit 2008 supplies power of the battery 240 to the communication unit 230, the operation unit 270, and the time tracking unit 250. The power control unit 2008 stops power supply of the battery 240 to the printing unit 260.

In the first sleep mode, the power control unit 2008 supplies power of the battery 240 to the start button 272 of the operation unit 270 and the time tracking unit 250. In the first sleep mode, the power control unit 2008 stops power supply of the battery 240 to the printing unit 260, the communication unit 230, and the operation button 271.

In the second sleep mode, the power control unit 2008 supplies power of the battery 240 to the time tracking unit 250. In the second sleep mode, the power control unit 2008 stops power supply to the printing unit 260, the communication unit 230, and the operation unit 270. That is, the power control unit 2008 stops power supply of the battery 240 to the printing unit 260, the communication unit 230, and the operation unit 270 based on the current time acquired by the time tracking unit 250 and the mode shift setting information 224. Specifically, if the third shift time set for the time zone belonging to the current time acquired by the time tracking unit 250 is elapsed, the mode control unit 2004 shifts the printer 20 to the second sleep mode. In the second sleep mode, the power control unit 2008 stops power supply of the battery 240 to the printing unit 260, the communication unit 230, and the operation unit 270.

The charge control unit 2009 controls the charge amount in which the battery 240 is charged based on the charge setting information 223. More specifically, the charge control unit 2009 charges the battery 240 until the proportion of the battery 240 charged reaches a proportion set in the charge setting information 223.

Next, the operation of the printer 20 will be described.

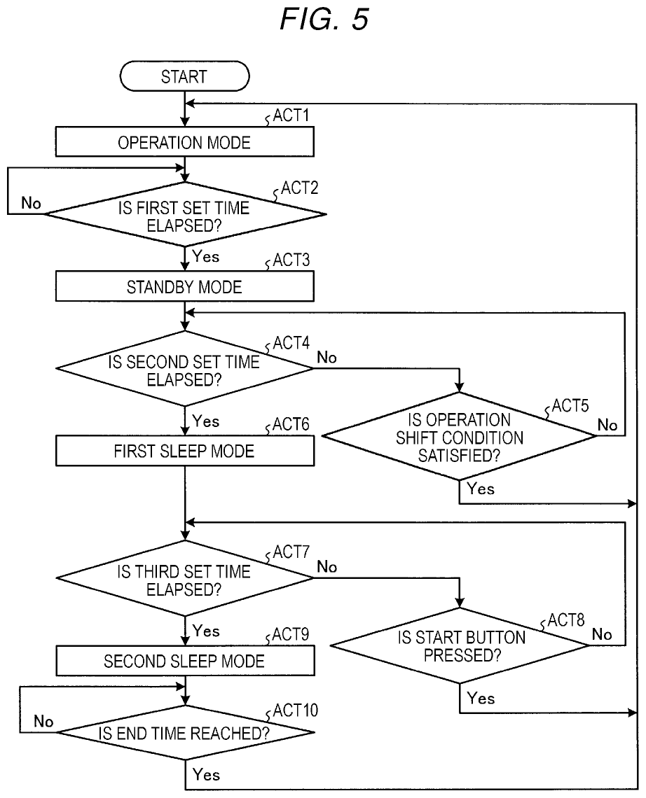

FIG. 5 is a flowchart illustrating an example of a mode shift process that is executed by the printer 20. The mode shift process is a process in which the printer 20 is shifted between the modes.

The mode control unit 2004 sets the printer 20 to the operation mode (ACT 1).

The mode control unit 2004 determines whether the first shift time is elapsed without using the printer 20 (ACT 2). If the first shift time is not elapsed (ACT 2: No), the mode control unit 2004 is on standby.

If the first shift time is elapsed without using the printer 20 (ACT 2: Yes), the mode control unit 2004 shifts the printer 20 to the standby mode (ACT 3).

The mode control unit 2004 determines whether the second shift time is elapsed (ACT 4). If the second shift time is not elapsed (ACT 4: No), the mode control unit 2004 determines whether the operation shift condition is satisfied (ACT 5). That is, the mode control unit 2004 determines whether the printer 20 is used, for example, such as receiving print request or receiving operation. If the operation shift condition is not satisfied (ACT 5: No), the mode control unit 2004 proceeds to ACT 4.

If the operation shift condition is satisfied (ACT 5: Yes) the mode control unit 2004 shifts the printer 20 to the operation mode in ACT 1.

If the second shift time is elapsed (ACT 4: Yes), the mode control unit 2004 shifts the printer 20 to the first sleep mode (ACT 6).

The mode control unit 2004 determines whether the third shift time is elapsed (ACT 7). If the third shift time is not elapsed (ACT 7: No), the mode control unit 2004 determines whether the start button 272 is pressed (ACT 8). If the start button 272 is not pressed (ACT 8: No), the mode control unit 2004 proceeds to ACT 7.

If the start button 272 is pressed (ACT 8: Yes), the mode control unit 2004 sets the printer 20 to the operation mode in ACT 1.

If the third shift time is elapsed (ACT 7: Yes), the mode control unit 2004 shifts the printer 20 to the second sleep mode (ACT 9).

The mode control unit 2004 determines whether the end time at which the second sleep mode ends is reached (ACT 10). If the end time of the second sleep mode is not reached (ACT 10: No), the mode control unit 2004 is on standby.

If the end time of the second sleep mode is reached (ACT 10: Yes), the mode control unit 2004 sets the printer 20 to the operation mode in ACT 1.

As a result, the printer 20 ends the mode shift process.

As a result, in the printer 20 according to the embodiment, the usage history recording unit 2005 records the usage history of the own apparatus in the usage history information 222. The mode shift setting unit 2006 sets the second shift time at which the printer 20 is shifted to the second sleep mode such that power supply is stopped to the mode shift setting information 224 based on the usage history information 222. That is, the mode shift setting unit 2006 sets a time zone in which the shift to the second sleep mode is allowed to the mode shift setting information 224. In the second sleep mode, the power control unit 2008 stops power supply of the battery 240 to the printing unit 260, the communication unit 230, and the operation unit 270 based on the current time and the mode shift setting information 224. As such, the printer 20 stops power supply in the time zone where the printer 20 is expected not to be used. Accordingly, the printer 20 can reduce power consumption.

In the description of the embodiment, if the third shift time is elapsed in the first sleep mode, the mode control unit 2004 is shifted to the second sleep mode. However, if the third shift time is elapsed in the standby mode, the mode control unit 2004 may shift the printer 20 to the second sleep mode. Alternatively, if the third shift time is elapsed in the operation mode, the mode control unit 2004 may shift the printer 20 to the second sleep mode.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and their equivalents are intended to cover such embodiments or modifications as would fall within the scope and spirit of the invention.

A program that is executed by each of the apparatuses according to the embodiment and the modification examples is embedded in a storage medium (for example, a ROM or a storage unit) in the apparatus in advance, but the embodiment is not limited thereto. For example, the program may be provided by being recorded in a computer-readable recording medium such as a CD-ROM, a flexible disk (FD), a CD-R, or a digital versatile disk (DVD) in an installable or executable file format. The storage medium is not limited to a medium separate from a computer or an embedded system and may be a storage medium that stores or temporarily stores a program downloaded through a LAN or the Internet.

The program that is executed by each of the apparatuses according to the embodiment and the modification examples may be provided by storing the program in a computer connected to a network such as the Internet and downloading the program through the network, or may be provided or distributed through a network such as the Internet.

What is claimed is:

1. A printer, comprising:
a printing component configured to execute printing;
a communication component configured to execute communication;
an operation component configured to receive an operation;
a time tracking component configured to acquire current time;
a first setting component configured to set a time zone in which power supply of a battery is stopped to first setting information based on a usage history of the printer; and
a power controller configured to stop power supply of the battery to the printing component, the communication component, and the operation component based on the current time acquired by the time tracking component and the first setting information.

2. The printer according to claim 1, further comprising:
a second setting component configured to set a charge amount in which the battery is charged to second setting information based on the usage history; and
a charge controller configured to control the charge amount in which the battery is charged based on the second setting information.

3. The printer according to claim 2, wherein
the second setting component changes the charge amount depending on a number of times the battery is charged.

4. The printer according to claim 1, wherein
the first setting component sets a shift time to the first setting information based on the usage history, and
if the shift time is elapsed, the power controller stops power supply.

5. The printer according to claim 4, wherein
the first setting component sets the shift time per the time zone based on the usage history, and
if the shift time set for the time zone belonging to the current time acquired by the time tracking component is elapsed, the power controller stops power supply.

6. The printer according to claim 1, wherein
the printer comprises at least four modes of power consumption selected from the group consisting of an operation mode, a standby mode, a first sleep mode, and a second sleep mode.

7. The printer according to claim 6, wherein
the operation mode comprises a printable state.

8. A method for a printer, comprising:
acquiring current time;
allowing a first setting unit to set a time zone in which power supply of a battery is stopped to first setting information based on a usage history of the printer; and
allowing a power controller to stop power supply of the battery to a printing component, a communication component, and a operation component based on the current time acquired and the first setting information.

9. The method according to claim 8, further comprising:
setting a charge amount in which the battery is charged to second setting information based on the usage history; and
controlling the charge amount in which the battery is charged based on the second setting information.

10. The method according to claim 9, further comprising:
changing the charge amount depending on a number of times the battery is charged.

11. The method according to claim 8, further comprising:
setting a shift time to the first setting information based on the usage history; and
if the shift time is elapsed, stopping the power supply.

12. The printer according to claim 11, further comprising:
setting the shift time per the time zone based on the usage history; and
if the shift time set for the time zone belonging to the current time acquired is elapsed, stopping the power supply.

13. The method according to claim 8, further comprising:
placing the printer into one four modes of power consumption selected from the group consisting of an operation mode, a standby mode, a first sleep mode, and a second sleep mode.

14. A printer system, comprising:
an information processing apparatus; and
a printer comprising:
a printing component configured to execute printing;
a communication component configured to execute communication;
an operation component configured to receive an operation;
a time tracking component configured to acquire current time;
a first setting component configured to set a time zone in which power supply of a battery is stopped to first setting information based on a usage history of the printer; and
a power controller configured to stop power supply of the battery to the printing component, the communication component, and the operation component based on the current time acquired by the time tracking component and the first setting information.

15. The printer system according to claim 14, the printer further comprising:
a second setting component configured to set a charge amount in which the battery is charged to second setting information based on the usage history; and
a charge controller configured to control the charge amount in which the battery is charged based on the second setting information.

16. The printer system according to claim 15, wherein
the second setting component changes the charge amount depending on a number of times the battery is charged.

17. The printer system according to claim 14, wherein
the first setting component sets a shift time to the first setting information based on the usage history, and
if the shift time is elapsed, the power controller stops power supply.

18. The printer system according to claim 17, wherein
the first setting component sets the shift time per the time zone based on the usage history, and
if the shift time set for the time zone belonging to the current time acquired by the time tracking component is elapsed, the power controller stops power supply.

19. The printer system according to claim 14, wherein
the printer comprises at least four modes of power consumption selected from the group consisting of an operation mode, a standby mode, a first sleep mode, and a second sleep mode.

20. The printer system according to claim 14, wherein
the information processing apparatus is a POS terminal.
